(19) United States
(12) Patent Application Publication
(10) Pub. No.: US 2016/0033795 A1
(43) Pub. Date: Feb. 4, 2016

(54) TESTING DEVICE, METHOD THEREOF, DISPLAY DEVICE AND DISPLAY METHOD THEREOF

(71) Applicants: BOE TECHNOLOGY GROUP CO., LTD., Beijing (CN); BEIJING BOE VISION-ELECTRONIC TECHNOLOGY CO., LTD., Beijing (CN)

(72) Inventors: Xiao ZHANG, Beijing (CN); Jianmin HE, Beijing (CN); Peng LI, Beijing (CN)

(21) Appl. No.: 14/424,238

(22) PCT Filed: Jul. 10, 2014
(86) PCT No.: PCT/CN2014/081986

§ 371 Date: Feb. 26, 2015

(30) Foreign Application Priority Data
Jan. 27, 2014 (CN) 201410040328.6

(51) Int. Cl. G02F 1/13; G09G 3/36

(52) U.S. Cl. CPC G02F 1/1309; G09G 3/3648; G09G 2320/0626; G09G 2320/0666; G09G 2320/0693

(57) ABSTRACT

A testing device and a method thereof, a display device and a display method are provided, relate to the display technology field, and avoid the non-uniform luminance distribution of backlight source due to a shorten light mixing distance of an LED lamp. The testing method includes: displaying a test image under an action of a backlight source; acquiring a luminance value of each pixel in the test image; and obtaining at least one compensation value according to the light distribution data, the compensation value being used as a basis for compensating the luminance value of each pixel of the test image to a standard luminance value.

### TECHNICAL FIELD

The embodiments of the present invention relate to the display technology field, particularly to a testing device and a method thereof, a display device and a display method thereof.

### BACKGROUND

An LCD (Liquid Crystal Display) is a passive light-emitting device that needs a BLU (Backlight Unite) to provide a light source for the liquid crystal display to display images. At present, the backlight source technologies mainly used by liquid crystal displays include: CCFL (Cold Cathode Fluorescent Lamp) and LEDs (Light Emitting Diodes). Since LED backlight sources have advantages such as high luminance, high color purity, long life, good reliability and no mercury pollution, they are occupying more and more percentage for use in backlight sources. As shown in FIG. 1, an LED backlight source 11 mainly includes: a backboard 110, a bottom reflection sheet 111, an LED lamp 112, a secondary optical lens 113, a diffusing plate 114, a diffusing sheet 115, a prism sheet 116. In FIG. 1, H represents the light mixing distance of the LED backlight source (usually the distance between the bottom of the LED backlight source 11 and the diffusing plate 114). Setting of the light mixing distance is mainly determined by the light emitting angle and the spacing of the LED lamp 112.

The inventors note in conceiving the present invention that at least the following problems exist in the state of art. In order to reduce the thickness of the liquid crystal display to meet ultra-thin design requirements, it is generally required to reduce the above-mentioned light mixing distance H. However, in so doing, reduction of the light mixing distance H would result in non-uniform distribution of the backlight source, thereby degrading the display effect of the liquid crystal display.

### SUMMARY

Embodiments of the present invention provide a testing device and a method thereof, a display device and a display method thereof that address the non-uniform distribution of luminance of the backlight source due to the shorten light mixing distance of an LED lamp.

In one aspect, an embodiment of the present invention provides a testing method comprising: displaying a test image under an action of a backlight source; acquiring light distribution data of the test image, wherein the light distribution data comprise a luminance value of each pixel of the test image; and obtaining at least one compensation value according to the light distribution data, the compensation value being used as a basis for compensating the luminance value of each pixel of the test image to a standard luminance value.

In another aspect, an embodiment of the present invention provides a testing device comprising: a display unit configured for displaying a test image under an action of a backlight source; an acquisition unit configured for acquiring light distribution data of the test image, wherein the light distribution data comprise a luminance value of each pixel of the test image; and an obtaining unit configured for obtaining at least one compensation value according to the light distribution data, the compensation value being used as a basis for compensating the luminance value of each pixel of the test image to a standard luminance value.

In still another aspect, an embodiment of the present invention provides a display device comprising: a receiving unit configured to receive image signals; a storage unit configured to store at least one compensation value and/or correction value obtained by the above testing device; a processing unit configured to adjust the luminance value of each pixel of the image signal to the standard luminance value according to at least one the compensation value and/or the correction value; and a display unit configured to display the image signals processed by the processing unit.

In further still another aspect, an embodiment of the present invention provides a display method, comprising: storing at least one compensation value and/or correction value obtained by the above testing device; receiving image signals; adjusting the luminance value of each pixel of the image signal to the standard luminance value according to at least one the compensation value and/or the correction value; and displaying the adjusted image signals.

Embodiments of the present invention provide a testing device and a method thereof, a display device and a display method, and the test method comprises displaying a test image under an action of a backlight source; acquiring light distribution data of the test image, wherein the light distribution data comprise a luminance value of each pixel of the test image; and obtaining at least one compensation value according to the light distribution data, the compensation value being used as a basis for compensating the luminance value of each pixel of the test image to a standard luminance value. In this way, using the at least one compensation value obtained by the above-mentioned testing method, it is possible to adjust the luminance value of each pixel in the image signal input into the display device to allow the luminance of each pixel close to or same as the luminance of standard pixel, thereby addressing non-uniform luminance distribution of the backlight source due to a shorten light mixing distance of an LED lamp, and in turn improving quality of displayed pictures while reducing the thickness of the display panel.

### BRIEF DESCRIPTION OF DRAWINGS

In order to explain embodiments of the present invention or technical solutions in prior art more clearly, accompanying drawings that need to be used in describing embodiments or prior arts will be briefly introduced below. Obviously, accompanying drawings in the following description are only some embodiments of the present invention, other drawings may be obtained by one of ordinary skill in the art based on these accompanying drawings without any creative labor.

FIG. 1 is a structural representation of a backlight source provided in the state of art;

FIG. 2 is a structural representation of a testing device provided in an embodiment of the present invention;

FIG. 3 is a structural representation of an acquisition unit provided in an embodiment of the present invention;

FIG. 4 is a structural representation of another testing device provided in an embodiment of the present invention; and

FIG. 5 is a structural representation of a display device provided in an embodiment of the present invention.

### DETAIL DESCRIPTION

The technical solutions of the embodiments will be described in a clearly and fully understandable way in connection with the drawings related to the embodiments of the invention. Apparently, the described embodiments are just a part but not all of the embodiments of the invention. Based on the embodiments of the present invention, those skilled in the art can obtain all other embodiment(s), without any inventive work, which should be within the scope of the invention.

An embodiment of the present invention provides a testing method comprising:

S101. displaying a test image under the action of the backlight source.

S102. acquiring light distribution data of the test image, wherein the light distribution data includes luminance values of all the pixels of the test image.

S103. obtaining at least one compensation value according to the above light distribution data, which is used as a basis for compensating the luminance value of each pixel in the test image to a standard luminance value.

An embodiment of the present invention provides a testing method comprising: displaying a test image under the action of the backlight source; acquiring a luminance value of each pixel in the test image; and obtaining at least one compensation value according to the light distribution data, which is used for compensating the luminance value of each pixel in the test image to a standard luminance value. In this way, using the at least one compensation value obtained by the above-mentioned testing method, it is possible to adjust the luminance value of each pixel in the image signal input into the display device to allow the luminance of each pixel close to or same as the luminance of standard pixel, thereby addressing non-uniform luminance distribution of the backlight source due to a shorten light mixing distance of an LED lamp, and in turn improving quality of displayed pictures while reducing the thickness of the display panel.

Furthermore, for example, the method of obtaining at least one compensation value according to the above-mentioned light distribution data may include:

S201. Converting a red R value, a green G value and a blue B value of each pixel into luminance L value, chrominance U value and V value.

It is to be noted that, each pixel of the test image is formed of red, blue and green (RGB) primary colors and each color of each pixel belongs to a sub-pixel; R represents red, G represents green, and B represents blue, and the above-mentioned test image is a RGB image. When the RGB format image is displayed, each primary color would form a color channel separately and the luminance of color of each channel is divided into 256 steps, from 0 to 255. Then the three monochrome channels are combined into one compound channel, namely the RGB channel. Colors of parts of the image are determined by values of three colors RGB in the compound channel. For example, when all the RGB values are 0, the part is black; when all the RGB color values are 255, the part is white. The RGB format image is the most common di splay image.

It is to be noted that LUV is a color encoding method in which L value represents luminance, that is, gray scale value; while U and V values represent chrominance with the function of describing image color and saturation for specifying color of a pixel. The luminance L value is established by testing R value, G value and B value of each pixel of the image, specifically, adding particular parts of RGB image signals together. While chrominance defines two aspects of the color, tone and saturation expressed by Cr and Cb respectively, Cr reflects the difference between the red parts in RGB image signals and the luminance value of RGB image signals, while Cb reflects the difference between the blue parts in RGB image signals and the luminance value of RGB image signals. For LUV images, the luminance value L and the chrominance values U, V of the images are separated. If for an LUV image, L value is not 0 while U, V values are both 0, such an image is a black and white gray scale image.

S202. Calculating an average luminance of all pixels according to the luminance L value of each pixel, wherein the standard luminance value is the above-mentioned average luminance.

Preferably, the standard luminance value is the average luminance, which is applied so that the display luminance would be neither so dark nor so bright to impact the display effect. In addition, it makes the difference between compensation values not too large and compensation values will become balanced with each other Of course, one skilled in the art can adjust setting/election of the standard luminance value according to practical requirements. For example, it is possible to take the maximum of luminance L value of all pixels as the standard luminance value, or take the minimum value of luminance L value of pixels as the standard luminance value. Furthermore, it is also possible to take the value of the maximum probability among luminance L values of pixels as the standard luminance value. It is not limited in the present invention.

S203. Calculating at least one compensation value between the luminance L value of each pixel and the standard luminance value.

S204. Storing the at least one compensation value.

In this way, by the above-mentioned steps, it is possible to convert an RGB format test image into an LUV test format image and obtain luminance L value of each pixel in the test image, so as to obtain at least one compensation value for compensating the luminance value of each pixel in the test image to the standard luminance value by comparing the luminance L value of each pixel with the standard luminance value. When a display device storing the above-mentioned compensation value is displaying images, it is possible to adjust the displayed images by invoking the above-mentioned compensation value to make the luminance of images displayed by the display device uniform, and in turn avoid non-uniform luminance distribution of the backlight source due to the shorten light mixing distance of an LED lamp, hence improving the display effect.

Furthermore, for example, the above-mentioned testing method may further include:

S301. Adjusting the luminance value of each pixel of the test image to the standard luminance value according to the compensation value to compensate the test image;

S302. Displaying the compensated test image;

S303. Acquiring the light distribution data of the compensated test image; and

S304. Calculating at least one correction value between the luminance L value of each pixel after compensation and the standard luminance value after compensation according to the acquired data and storing the at least one correction value. In this way, it is possible to obtain the above-mentioned correction value. The correction value may be used to correct the compensated test image for luminance of each pixel to reduce difference among pixels, thereby ensuring optimal effect of uniform luminance.

It is noted that each pixel of the test image includes a red R value, a green G value and a blue B value. The test image may be a gray scale image with the above-mentioned red R value, green G value and blue B value being all equal, or may be a full color image with a red R value, a green G value and a blue B value at the same time; or a full red image with a red R value being 255 and a green G value and a blue B value both being zero; or may be a full green image with a green G value being 255 and a red R value and a blue B value both being zero; or may also be a full blue image with a blue B value being 255 and a red R value and a green G value both being zero.

Preferably, the test image is a gray scale image. Because gray scale represents the hierarchical levels of different luminance of an image from the darkest state to the brightest state, the more intermediate levels there are, the refiner picture effect can be presented, and also gray scale images can best reflect luminance information of images. In this way, using a gray scale image as the test image and after luminance adjustment, it is possible to obtain the luminance distribution of the gray scale image in a more intuitively way.

Of course, the above is only the illustration of the test image, and other types of applicable test images will not be detailed but shall fall within the scope of the present invention.

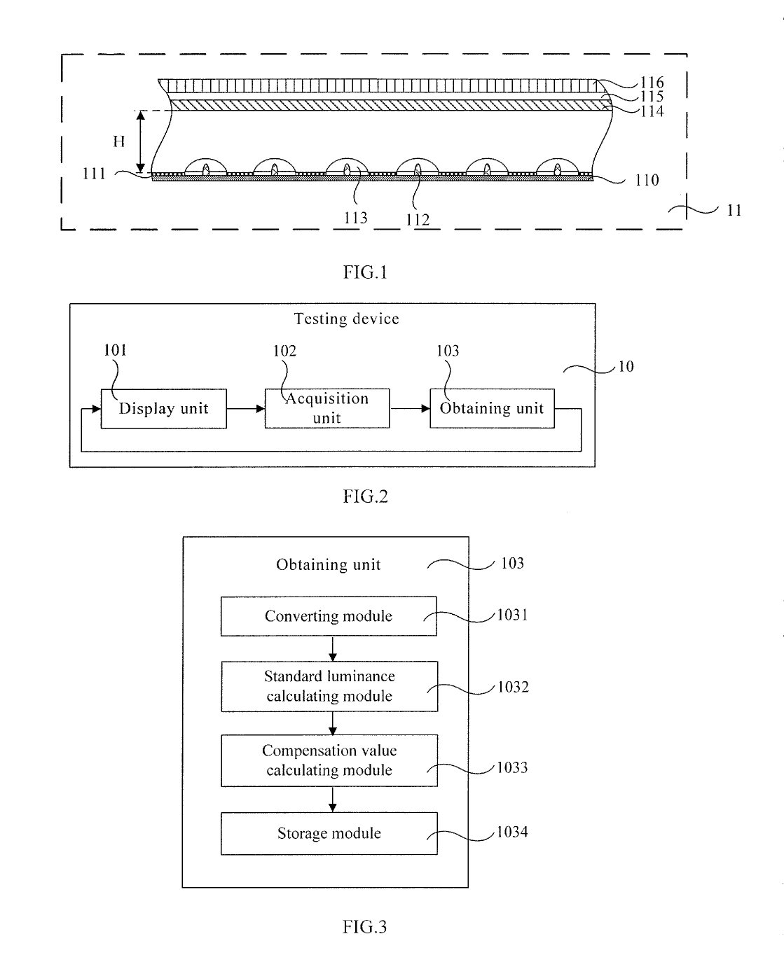

An embodiment of the present invention provides a testing device 10 as shown in FIG. 2, and the device may include:

a display unit 101 for displaying a test image under the action of a backlight source;

an acquisition unit 102 for acquiring the light distribution data of the test image, wherein the light distribution data includes a luminance value of each pixel in the test image; and

an obtaining unit 103 for obtaining at least one compensation value according to the above-mentioned light distribution data which is to be used as the basis for compensating the luminance value of each pixel of the test image to the standard luminance value.

An embodiment of the present invention provides a testing device comprising: a display unit configured for displaying a test image under the action of a backlight source; an acquisition unit configured for acquiring a luminance value of each pixel of the test image; and an obtaining unit configured for obtaining at least one compensation value according to the test image which is used for compensating the luminance value of each pixel of the test image to the standard luminance value. In this way, using the at least one compensation value obtained by the above-mentioned testing method, it is possible to adjust the luminance value of each pixel in the image signal input into the display device to allow the luminance of each pixel close to or same as the luminance of standard pixel, thereby addressing non-uniform luminance distribution of the backlight source due to the shorten light mixing distance of an LED lamp, and in turn improving quality of displayed pictures while reducing the thickness of the display panel.

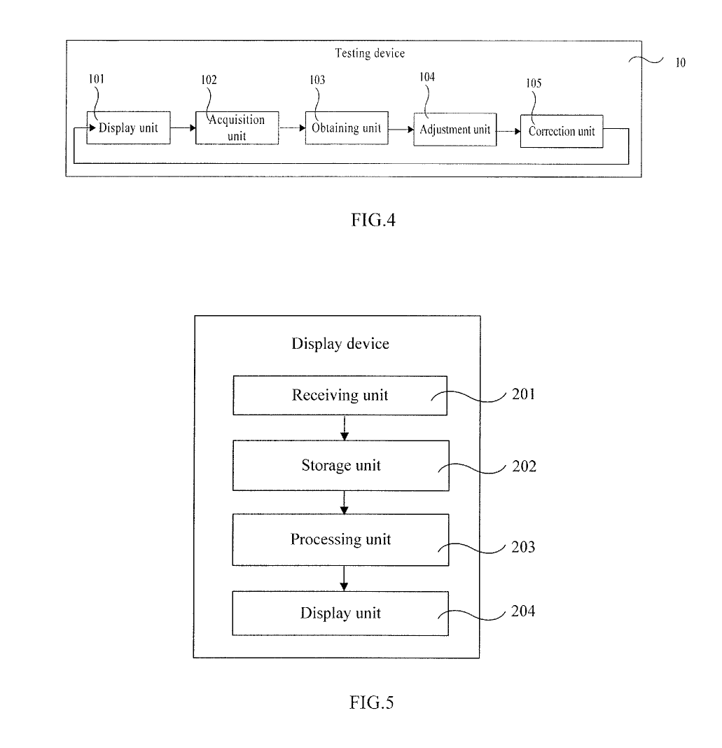

Furthermore, as shown in FIG. 3, the obtaining unit 103 may include: a converting module 1031, a standard luminance calculating module 1032, a compensation value calculating module 1033 and a storage module 1034.

The converting module 1031 is configured to convert the red R value, the green G value and the blue B value of each pixel into the luminance L value, chrominance U value and V value.

It is to be noted that, each pixel of the test image is formed of the red, blue and green (RGB) primary colors and each color on each pixel is in a sub-pixel, where “R” represents red, “G” represents green, and “B” represents blue, and the above-mentioned test image is an RGB image. When the RGB format image is displayed, each primary color form a color channel separately, and the luminance of the color on each channel is divided into 256 steps, i.e., from 0 to 255. Then the three monochrome channels are combined together into one compound channel, namely the RGB channel. Colors of parts of the image are determined by the values of three colors RGB in the compound channel. For example, when all the RGB values are 0, the part is black; when all the RGB color values are 255, the part is white. The RGB format image is the most common display image.

It is to be noted that LUV is a color encoding method where L value represents luminance, that is, a gray scale value, while U and V values represent chrominance for describing the tone and saturation of a color of a pixel of an image. The luminance L value is established by testing the R value, G value and B value of each pixel of the image, specifically, adding particular parts of RGB image signals together. While chrominance defines two aspects of the color, i.e., tone and saturation expressed by Cr and Cb respectively, where Cr reflects the difference between the red parts in RGB image signals and the luminance value of RGB image signals, while Cb reflects the difference between the blue parts in RGB image signals and the luminance value of RGB image signals. For LUV format images, luminance value L and chrominance values U, V of the images are independent from each other. If the LUV format image has only L value but not U and V values, then such an image is a black and white gray scale image.

The standard luminance calculating module 1032 is configured to calculate an average luminance of all pixels according to the luminance L value of each pixel, and the standard luminance value is the average luminance.

Preferably, the standard luminance value is the average luminance so that the display luminance would be neither so dark nor so bright to impact the display effect. In addition, it makes the difference between the compensation values not too large, and the compensation values will be balanced with each other. One skilled in the art can adjust the setting of the standard luminance value according to practical requirements. For example, it is possible to take the maximum of luminance L value of all pixels as the standard luminance value, or take the minimum value of luminance L value of pixels as the standard luminance value. Furthermore, it is also possible to take the value of maximum probability in luminance L values of pixels as the standard luminance value. It is not limited in the present invention.

The compensation value calculating module 1033 is configured to calculate at least one compensation value between the luminance L value of each pixel and the standard luminance value.

The storage module 1034 is configured to store the at least one compensation value.

In this way, the above-mentioned obtaining unit may convert an RGB test image into an LUV test image and in turn obtain the luminance L value of each pixel of the test image, so as to obtain at least one compensation value required to compensate the luminance value of each pixel of the test image to the standard luminance value by comparing the luminance L value of each pixel with the standard luminance value. When a display device storing the above-mentioned compensation value is displaying images, it is possible to adjust the displayed images by invoking the above-mentioned compensation value to make the luminance of images displayed by the display device uniform, and in turn avoid non-uniform luminance distribution of the backlight source due to a shorten light mixing distance of an LED lamp, hence improving the display effect.

Furthermore, as shown in FIG. 4, the testing device 10 may further include an adjustment unit 104 and a correction unit 105.

The adjustment unit 104 is configured to adjust the luminance value of each pixel of the test image to the standard luminance value according to the compensation value.

The correction unit 105 is configured to calculate at least one correction value between the luminance L value of each pixel after compensation and the standard luminance value after compensation by the standard luminance calculating module 1032 and the compensation value calculating module 1033 according to the data acquired by the acquisition unit 102, and store the at least one correction value by the storage module 1034. The data acquired by the acquisition unit 102 includes the light distribution data of the compensated test image displayed by the display unit 101. In this way, it is possible to obtain the above-mentioned correction value by the correction unit 105. The correction value may be used to correct compensated test image for the luminance of each pixel to reduce difference among pixels, thereby ensuring optimal effect of uniform luminance.

Furthermore, it is also possible to repeatedly use the adjustment unit 104 and the correction unit 105 to optimize the compensation value and the correction value stored in the storage module 1034 to thereby achieve the optimal compensation or correction effects.

Preferably, the acquisition unit 102 may include a CCD (Charge-coupled Device). Specifically, a CCD is a semiconductor device with many regularly aligned capacitors that can sense light, and it can function as a film but can convert image pixels into digital signals. In this way, a CCD camera acting as the acquisition unit 102 can not only acquire the test image displayed by the display unit 101, but also can generate digital signals corresponding to the test image such that the obtaining unit 103 can receive the digital signals and implement data processing on them. Some embodiments of the present invention are described with the CCD camera being the acquisition unit 102 as an example. Other acquisition units will not be described herein, but all shall fall within the scope of the present invention. Preferably, the acquisition unit 102 may have a resolution same as that of the display device which can realize one-to-one correspondence of pixels. In this way, it is possible to facilitate the acquisition unit 102 to collect and process light distribution data of each pixel.

The implementation process of the testing device is specifically as follows: the acquisition unit 102 acquires the test image displayed by the display unit 101 and generates digital signals to be input into the obtaining unit 103. The converting module 1031 of the obtaining unit 103 separates colors for the signal, amplifies and corrects them respectively to obtain the red R value, the green G value and the blue B value of each pixel. Then the luminance L value, the chrominance U value and V value are obtained via matrix transformation by the converting module 1031 to convert the format of the test image from RGB format to the LUV format. Similarly, an LUV test image may be restored into an RGB test image by the matrix circuit of the converting module 1031. Then, a required standard luminance value such as the average luminance of all pixels is determined by the standard luminance calculating module 1032 according to the luminance L value of each pixel to enable the compensation value calculating module 1033 to calculate the compensation value between the luminance L value of each pixel and the above-mentioned standard luminance value according to the standard luminance value. The above-mentioned compensation value is stored in the storage module 1034. It is also possible to calculate at least one correction value between the luminance L value of each pixel after compensation and the standard luminance value after compensation by the correction unit 105 and store the at least one correction value.

Specifically, the testing method in connection with the above-mentioned testing device may include the following steps S401 to S410.

S401. Selecting a test image. It is possible to select an image of any gray scale value from among images with gray scale of 0-255, for example, one with the gray scale value of 127 as the test image.

S402. Inputting the gray scale image to the LCD display device via a signal generator device and displaying the above-mentioned gray scale image at the LCD display device with illumination by the backlight source.

S403. Acquiring, through a CCD camera, the gray scale image displayed by the LCD display device and generating digital signals, and inputting the digital signals into the computer control system.

S404. Analyzing and calculating, by the computer control system, the backlight distribution according the above-mentioned digital signals and obtaining at least one compensation value according to the test image, which is used as the basis for compensating the luminance value of each pixel of the test image to the standard luminance value.

It is to be noted that since the backlight distribution is mainly reflected by the luminance of all pixels of the image displayed by the display device, generally an RGB image displayed by an LCD display device, the image information acquired by the CCD camera describes pixel points through the RGB space. Furthermore, because embodiments of the present invention mainly adjust luminance information, it is required that the matrix circuit implements transformation from the RGB space into the LUV space with respect to the acquired image information, where L component represents luminance information, and U and V components are chrominance information. Therefore, in embodiments of the present invention, the computer control system can analyze and adjust only L component.

Specifically, the transformation from the RGB space to the LUV space is as follows:

Firstly, the RGB space is transformed into the CIEXYZ (a primary color system) space:

$$[ \begin{matrix}X \\ Y \\ Z\end{matrix} ] = \frac{1}{0.17697} [ \begin{matrix}0.49 & 0.31 & 0.20 \\ 0.17697 & 0.81240 & 0.01063 \\ 0.00 & 0.01 & 0.99\end{matrix} ] [ \begin{matrix}R \\ G \\ B\end{matrix} ]$$

Then, the CIEXYZ space is transformed into the LUV space:

$$L = \{ \begin{matrix}116 {( \frac{Y}{{Y}_{n}} )}^{1 / 13} - 16 , & \frac{Y}{{Y}_{n}} > {( \frac{6}{29} )}^{3} \\ {( \frac{29}{3} )}^{3} ( \frac{Y}{{Y}_{n}} ) , & \frac{Y}{{Y}_{n}} \leq {( \frac{6}{29} )}^{3}\end{matrix} \\ U = 13 L \times ( {U}^{′} - {U}_{n}^{′} ) \\ V = 13 L \times ( {V}^{′} - {V}_{n}^{′} ) \\ Where \\ {U}^{′} = \frac{4 X}{X + 15 Y + 3 Z} \\ {V}^{′} = \frac{9 Y}{X + 15 Y + 3 Z}$$

According to D65 standard illuminator,

Yₙ=1.0

S405. Calculating an average luminance of all pixels and using the average luminance as the standard luminance value.

S406. Calculating a compensation value between the luminance L value of each pixel and the standard luminance value and establishing a data sheet for storing the above-mentioned compensation value.

Specifically, the standard luminance value may be the average luminance L̅ of all pixel points in the test image. The luminance value L of each pixel is compared with the average luminance L̅ of the test image. When the absolute value of the luminance difference Δ=|L− L̅| between the luminance value L of each pixel and the average luminance value L̅ is greater than a preset threshold, the luminance of each pixel point is adjusted to the standard luminance value. If Δ=|L− L̅| is smaller than the threshold, the acquired luminance of pixel points is kept constant.

Since human eyes are less sensitive to low gray scale and high gray scale images have poor detail resolution capability, the above-mentioned selection of threshold may be set according to the average luminance L̅. For example, the absolute value of the luminance difference between the above-mentioned luminance value L of each pixel and the average luminance value L̅ may be:

$$Δ = \vert L - \overline{L} \vert = \{ \begin{matrix}5 & if \overline{L} < 16 \\ 2 & if 16 \leq \overline{L} \leq 240 \\ 5 & if \overline{L} > 224 \end{matrix}$$

S407. Adjusting the luminance value of each pixel in the test image to the above-mentioned standard luminance value according to the compensation value stored in the data sheet.

S408. Displaying the compensated test image.

S409. Acquiring the light distribution data of the compensated test image.

S410. Calculating at least one correction value between the luminance L value of each pixel after compensation and the standard luminance value after compensation according to the acquired data and storing the at least one correction value.

In this way, it is possible to obtain the above-mentioned correction value. The correction value may be used to correct the compensated test image for the luminance of each pixel to reduce difference among pixels, thereby ensuring optimal effect of uniform luminance.

An embodiment of the present invention provides a display device as shown in FIG. 5, including a receiving unit 201, a storage unit 202, a processing unit 203 and a display unit 204.

The receiving unit 201 is configured to receive image signals.

The storage unit 202 is configured to acquire at least one compensation value and/or correction value by the above-mentioned testing device, and the compensation value or the correction value is used to compensate the luminance value of each pixel of the test image to the standard luminance value.

The processing unit 203 is configured to adjust the luminance value of each pixel of the image signal to the standard luminance value according to at least one compensation value and/or correction value.

The display unit 204 is configured to display the image signals processed by the processing unit 203.

The embodiment of the present invention provides a display device including a receiving unit configured to receive image signals; A storage unit storing the at least one compensation value acquired by the above-mentioned testing device; A processing unit configured to adjust the luminance value of each pixel of the image signal to the standard luminance value according to at least one compensation value; and the display unit configured to display the image signals processed by the processing unit. In this way, since the display device stores compensation values and/or correction values for adjusting the luminance of each pixel of the displayed image to the standard luminance, it is possible to adjust the displayed images before displaying the images by invoking the above-mentioned compensation values to make the luminance of images displayed by the display device uniform, thereby avoiding non-uniform luminance distribution of backlight source due to a shorten light mixing distance of an LED lamp and improving the display effect.

It is to be noted that in the embodiment of the present invention, the display device may specifically include a liquid crystal display device. For example, the display device may be any product or component with display function such as a liquid crystal display, a liquid crystal TV set, a digital picture frame, a cell phone, or a flat computer.

It is to be noted that when the above-mentioned display device is displaying, the luminance of each pixel of the pre-displayed images is adjusted by invoking the compensation values obtained by the testing device. Since in the process of homogenizing treatment of luminance for the pre-displayed images, the format of the pre-displayed images is LUV, after the luminance adjustment, it is required to restore LUV images into RGB images.

Specifically, the transformation from LUV space to RGB space is:

Firstly, the LUV space is transformed into CIEXYZ space:

$$Y = \{ \begin{matrix}{Y}_{n} \times {L}^{′} \times {( \frac{3}{29} )}^{3} , & {L}^{′} \leq 8 \\ {Y}_{n} \times {( \frac{{L}^{′} \times 16}{116} )}^{3} , & {L}^{′} > 8\end{matrix}$$

Where L′ is the luminance value of adjusted pixel points.

$$X = Y \times \frac{9 {U}^{′}}{4 {V}^{′}}$$

$$Z = Y \times \frac{13 - 3 {U}^{′} - 20 {V}^{′}}{4 {V}^{′}}$$

Then, the CIEXYZ space is transformed into the RGB space:

$$[ \begin{matrix}R \\ G \\ B\end{matrix} ] = \frac{1}{5.6508} [ \begin{matrix}2.3646 & - 0.8966 & - 0.4681 \\ - 0.5152 & 1.4246 & 0.0888 \\ 0.0052 & - 0.0144 & 1.0092\end{matrix} ] [ \begin{matrix}X \\ Y \\ Z\end{matrix} ]$$

Then, the images with adjusted luminance are input into the LCD display device for display by the signal generator device.

The embodiment of the present invention provides a display method including the following steps:

S501. Storing at least one compensation value and/or correction value acquired by the above-mentioned testing device, where the compensation value or the correction value is used to compensate the luminance value of each pixel of the test image to the standard luminance value.

S502. Receiving image signals.

S503. Adjusting the luminance value of each pixel of the image signal to the standard luminance value according to at least one compensation value and/or correction value.

S504. Displaying the adjusted image signals.

The embodiment of the present invention provides a display method including storing the at least one compensation value acquired by the above-mentioned testing device; receiving image signals; adjusting the luminance value of each pixel of the image signal to the standard luminance value according to at least one compensation value; displaying the adjusted image signals. In this way, since the method stores compensation values and/or correction values for adjusting luminance of each pixel of the displayed image to the standard luminance, it is possible to adjust the displayed images before displaying the images by invoking the above-mentioned compensation values to make the luminance of images displayed by the display device uniform, thereby avoiding non-uniform luminance distribution of backlight source due to a shorten light mixing distance of an LED lamp and improving the display effect.

Those skilled in the art can understand the following facts. All or some steps for realizing the above-mentioned method embodiment may be accomplished by hardware related to program instructions. The aforementioned program may be stored in a computer readable storage medium, which when executed, carries out steps including the above-mentioned method embodiment. While the aforementioned storage medium includes various media that can store program codes such as ROMs, RAMs, disks or optical disks.

What have been described above are only specific implementations. However, the scope of the present invention is not limited thereto. One skilled in the art can easily contemplate variations or substitutions within the technical scope disclosed by the present invention, which should all be covered in the scope of the present invention. Therefore, the scope of the present invention should be defined by the scope of the described claims.

The present application claims priority of a China patent application no. 201410040328.6 filed on Jan. 27, 2014, which is incorporated in its entirety herein by reference as part of the present application.

1. A testing method comprising:
displaying a test image under an action of a backlight source;
acquiring light distribution data of the test image, wherein the light distribution data comprise a luminance value of each pixel of the test image; and
obtaining at least one compensation value according to the light distribution data, the compensation value being used as a basis for compensating the luminance value of each pixel of the test image to a standard luminance value.

2. The testing method of claim 1, wherein obtaining at least one compensation value according to the light distribution data comprises:
converting a red R value, a green G value and a blue B value of each pixel into a luminance L value, a chrominance U value and V value;
calculating an average luminance of all pixels according to the luminance L value of each pixel, the standard luminance value being the average luminance;
calculating the at least one compensation value between the luminance L value of each pixel and the standard luminance value; and
storing the at least one compensation value.

3. The testing method of claim 1, further comprising:
adjusting the luminance value of each pixel in the test image to the standard luminance value according to the compensation value;
displaying a compensated test image;
acquiring light distribution data of the compensated test image; and
calculating at least one correction value between a luminance L value of each pixel after compensation and a standard luminance value after compensation according to the acquired data and storing the at least one correction value.

4. The testing method of claim 1, wherein the test image is a gray scale image.

5. A testing device comprising:
a display unit configured for displaying a test image under an action of a backlight source;
an acquisition unit configured for acquiring light distribution data of the test image, wherein the light distribution data comprise a luminance value of each pixel of the test image; and
an obtaining unit configured for obtaining at least one compensation value according to the light distribution data, the compensation value being used as a basis for compensating the luminance value of each pixel of the test image to a standard luminance value.

6. The testing device of claim 5, wherein the obtaining unit comprises:
a converting module for converting a red R value, a green G value and a blue B value of each pixel into a luminance L value, a chrominance U value and V value;
a standard luminance calculating module for calculating an average luminance of all pixels according to the luminance L value of each pixel, the standard luminance value being the average luminance;
a compensation value calculating module for calculating the at least one compensation value between the luminance L value of each pixel and the standard luminance value; and
a storage module for storing the at least one compensation value.

7. The testing device of claim 5, further comprising:
an adjustment unit configured for adjusting the luminance value of each pixel in the test image to the standard luminance value according to the compensation value; and
a correction unit configured for calculating at least one correction value between the luminance L value of each pixel after compensation and the standard luminance value after compensation by the standard luminance calculating module and the compensation value calculating module according to data acquired by the acquisition unit and storing the at least one correction value by the storage module;
wherein data acquired by the acquisition unit comprises light distribution data of compensated test image displayed by the display unit.

8. The testing device of claim 5, wherein the acquisition unit comprises a charge coupled device.

9. A display device comprising:
a receiving unit configured to receive image signals;
a storage unit configured to store at least one compensation value and/or correction value obtained by the testing device of claim 5;
a processing unit configured to adjust the luminance value of each pixel of the image signal to the standard luminance value according to at least one the compensation value and/or the correction value; and
a display unit configured to display the image signals processed by the processing unit.

10. (canceled)

11. The testing method of claim 2, further comprising:
adjusting the luminance value of each pixel in the test image to the standard luminance value according to the compensation value;
displaying a compensated test image;
acquiring light distribution data of the compensated test image; and
calculating at least one correction value between a luminance L value of each pixel after compensation and a standard luminance value after compensation according to the acquired data and storing the at least one correction value.

12. The testing method of claim 2, wherein the test image is a gray scale image.

13. The testing device of claim 6, further comprising:
an adjustment unit configured for adjusting the luminance value of each pixel in the test image to the standard luminance value according to the compensation value; and
a correction unit configured for calculating at least one correction value between the luminance L value of each pixel after compensation and the standard luminance value after compensation by the standard luminance calculating module and the compensation value calculating module according to data acquired by the acquisition unit and storing the at least one correction value by the storage module;
wherein data acquired by the acquisition unit comprises light distribution data of compensated test image displayed by the display unit.

14. The testing device of claim 6, wherein the acquisition unit comprises a charge coupled device.
